(19) United States
(12) Patent Application Publication
(10) Pub. No.: US 2016/0344531 A1
(43) Pub. Date: Nov. 24, 2016

(54) SYSTEMS AND METHODS FOR FREQUENCY MULTIPLEXING MU-MIMO

(71) Applicant: INTEL IP CORPORATION, Santa Clara, CA (US)

(72) Inventors: Guoqing C. Li, Portland, OR (US); Robert J. Stacey, Portland, OR (US)

(21) Appl. No.: 15/112,897

(22) PCT Filed: Aug. 29, 2014
(86) PCT No.: PCT/US2014/053451

§ 371 Date: Jul. 20, 2016

Related U.S. Application Data
(60) Provisional application No. 61/944,194, filed on Feb. 25, 2014.
(60) Provisional application No. 61/986,256, filed on Apr. 30, 2014.
(60) Provisional application No. 61/986,250, filed on Apr. 30, 2014.

(51) Int. Cl. H04L 5/00; H04W 72/04; H04B 7/04

(52) U.S. Cl. CPC H04L 5/0094; H04B 7/0452; H04L 5/0007; H04L 5/0053; H04W 72/04

(57) ABSTRACT

Generally discussed herein are systems and apparatuses that may include frequency multiplexing in a DownLink (DL) Multi-User (MU) Multiple Input Multiple Output (MIMO) transmission. The disclosure also includes techniques of making and using the systems and apparatuses. According to an example, an apparatus may include circuitry to transmit to a first Station (STA) on a first sub-channel a first Medium Access Control (MAC) frame or a first preamble and transmit to a second STA on a second sub-channel different than the first sub-channel, a second MAC frame or a second preamble different from the first MAC frame and the first preamble, respectively.

### RELATED WIRELESS DEVICE APPLICATIONS

This application claims the benefit of priority to U.S. Provisional Patent Application Ser. No. 61/944,194, filed on Feb. 25, 2014, U.S. Provisional Patent Application Ser. No. 61/986,256 filed Apr. 30, 2014, and U.S. Provisional Patent Application Ser. No. 61/986,250 filed Apr. 30, 2014, which are all incorporated herein by reference in their entireties.

### TECHNICAL FIELD

Examples generally relate to systems and methods for frequency multiplexing in DownLink (DL) in a Multi-User (MU) Multiple Input, Multiple Output (MIMO) system. Some embodiments relate to High-Efficiency Wireless (HE-W) Local Area Network (LAN) or High Efficiency Wi-Fi (HEW) and the Institute of Electrical and Electronics Engineers (IEEE) 802.11ax standard. Some embodiments relate to the 802.11ac standard.

### BACKGROUND

A wireless communication network may help a device gain access to information, signaling resources, and other resources. The network may include a base station or wireless device (e.g., Access Point (wireless device)) that delegates device access to the resources of the cellular network. The wireless device may act as a sort of gate keeper for network resources.

MU-MIMO is a form of spatial multiplexing where different spatial streams are directed to or originate from different users. In MU-MIMO, a plurality of wireless devices and transmitter devices are coupled through antennas. Using MU-MIMO multiple transmitters may send separate signals and multiple receivers may receive the separate signals simultaneously and in the same band.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example of a system, in accord with to one or more embodiments.

FIG. 2A shows an example of a MAC frame, in accord with one or more embodiments.

FIG. 2B shows a block diagram of a frame preamble, in accord with one or more embodiments.

FIG. 3 shows a block diagram of an example of a MAC frame, in accord with one or more embodiments.

FIG. 4 shows a block diagram of an example of a preamble, in accord with one or more embodiments.

FIG. 5 shows a flow diagram of an example of a technique for frequency multiplexing a MU-MIMO transmission, in accord with one or more embodiments.

FIG. 6 shows a block diagram of an example of a computer system.

### DETAILED DESCRIPTION

Examples in this disclosure relate generally to frequency multiplexing in DL in a MU-MIMO. In one or more embodiments, this disclosure discusses an extension to 802.11ac DL-MU-MIMO to support OFDMA based on existing 802.11ac framework.

The Institute of Electrical and Electronics Engineers (IEEE) High Efficiency Wi-Fi (HEW) study group is considering supporting Orthogonal Frequency Division Multiple Access (OFDMA) to increase the system capacity. 802.11ac already supports MU-MIMO in the Down Link (DL). Currently there is no solution on how to support frequency domain multiplexing (e.g., OFDMA) when MU-MIMO is used in DL.

DL MU-MIMO signaling (e.g., Medium Access Control (MAC) management frames and Physical Layer Protocol (PHY) preamble signaling) currently is done across the entire channel without consideration of a frequency domain multiplexing operation. When frequency domain multiplexing is used, the signaling may be done on a per sub-channel basis.

Currently, 802.11ac MU-MIMO is done generally as follows. A MAC management unicast frame is broadcast to indicate to each Station (STA) its association to each MU-MIMO group and the relative spatial stream index(es) in the MU-MIMO group that the STA is to monitor.

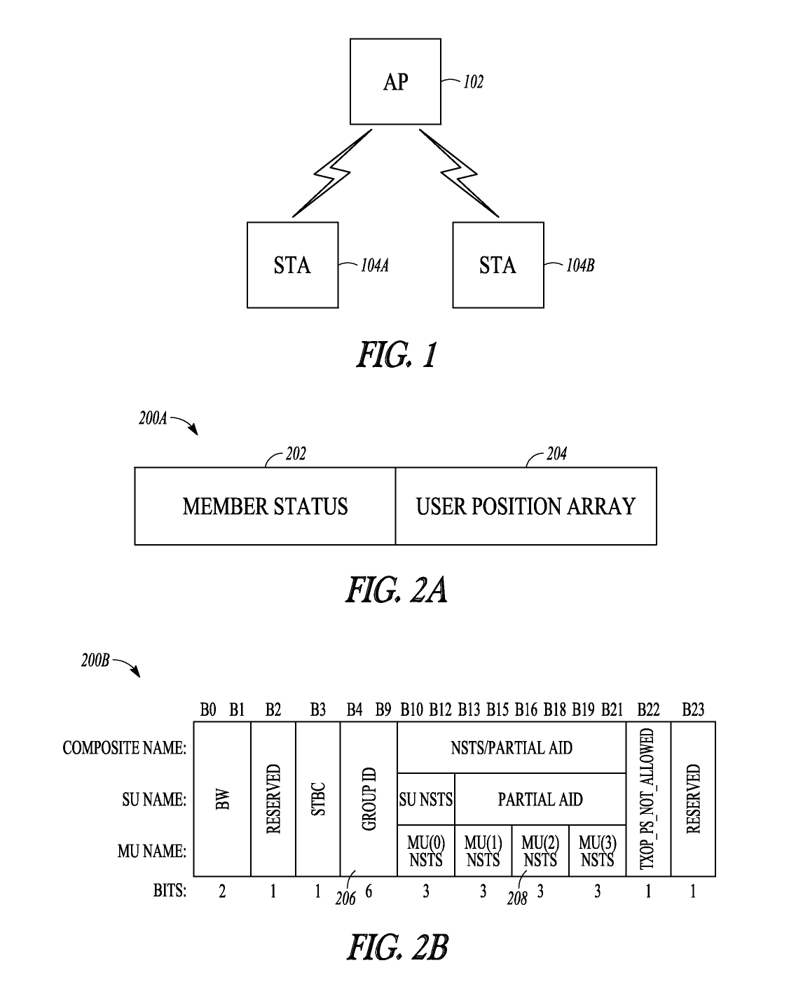

FIG. 1 shows an example of a system 100 according to one or more embodiments. The system 100 may include a wireless device 102 (e.g., a Wireless Local Area Network (WLAN) wireless device, such as a Wireless Fidelity (WiFi) wireless device). The system 100 may include a plurality of Stations (STAs) 104A or 104B. The STA 104A-B may be a User Equipment (UE) device. The STA 104A-B may be a wireless communication device (e.g., laptop, desktop computer, Personal Digital Assistant (PDA), phone, or the like), or other device that has the capability to use the protocol detailed herein. The STA 104A-B or the wireless device 102 may be mobile or stationary.

The wireless device 102 may send transmissions to the STA 104A-B and the STA 104A-B may send transmissions to the wireless device 102. The wireless device 102 may send transmissions in a MU-MIMO on a DL. The wireless device 102 may include circuitry to implement frequency multiplexing thereon, such as to provide a MU-MIMO DL with frequency multiplexing. Such a configuration may increase the bandwidth offered to an STA or increase the number of STAs that be serviced by the wireless device 102.

In accordance with some HEW embodiments, the wireless device 102 may operate as a master STA which may be arranged to contend for a wireless medium (e.g., during a contention period) to receive exclusive control of the medium for an HEW control period (i.e., a transmission opportunity (TXOP)). The master STA may transmit an HEW master-sync transmission at the beginning of the HEW control period. During the HEW control period, HEW STAs may communicate with the master STA in accordance with a non-contention based multiple access technique. This is unlike conventional Wi-Fi communications in which devices communicate in accordance with a contention-based communication technique, rather than a multiple access technique. During the HEW control period, the master STA may communicate with HEW STAs using one or more HEW frames. During the HEW control period, legacy STAs refrain from communicating. In some embodiments, the master-sync transmission may be referred to as an HEW control and schedule transmission.

In some embodiments, the multiple-access technique used during the HEW control period may be an OFDMA technique. In some embodiments, the multiple access technique may be a time-division multiple access (TDMA) technique or a frequency division multiple access (FDMA) technique.

The master STA may communicate with legacy STAs in accordance with legacy IEEE 802.11 communication techniques. In some embodiments, the master STA may be configured to communicate with HEW STAs outside the HEW control period in accordance with legacy IEEE 802.11 communication techniques.

In some embodiments, the links of an HEW frame may be configurable to have the same bandwidth and the bandwidth may be one of 20 MHz, 40 MHz, 80 MHz or 160 MHz. In some embodiments, a 320 MHz bandwidth may be used. In these embodiments, each link of an HEW frame may be configured for transmitting a number of spatial streams.

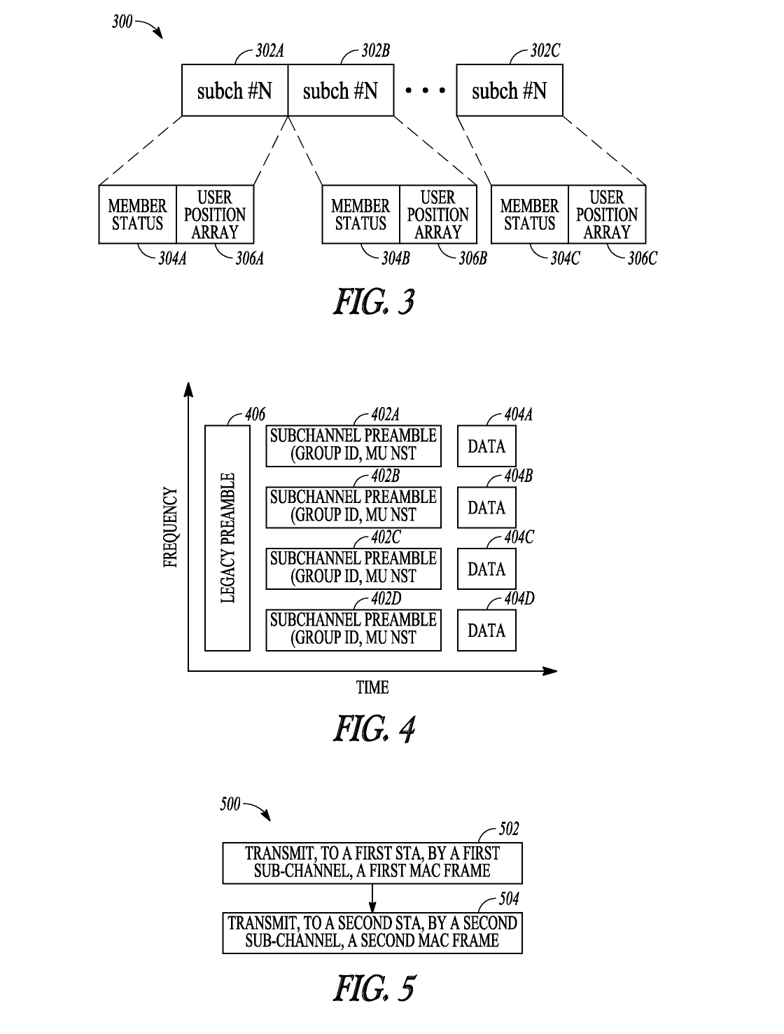

FIG. 2A shows a block diagram of a legacy MAC frame 200A that is sent to the STA. This MAC frame is called “Group ID and partial AID action frame” and carries the member status 202 and the user position array 204.

The member status 202 is a bitmap indicating an STA's association for each MU-MIMO group (up to 64 groups currently). The user position array 204 indicates the index of the spatial stream the STA is to monitor, if the STA is in the MU-MIMO group.

FIG. 2B shows a block diagram of a legacy preamble 200B frame that indicates the group ID and the user spatial stream allocation. Based on previous MAC management frame, such as shown in FIG. 2A, the STA may look up and decide whether it is to receive and which stream it is to receive data on. The STA may verify that the member status 202 and the Group ID 206 are consistent and may look up which spatial stream(s) to monitor in the MU Number of Space Time Streams (NSTS) field 208.

FIG. 3 shows a block diagram of an example of a MAC configuration frame 300, according to one or more embodiments. In order to support frequency domain multiplexing, the current MAC management frame's Group ID and partial AID action frame may be extended to convey MU-MIMO group information on a per-sub-channel basis. This frame may be considered a “Multiuser Group ID and partial AID action frame”. The MAC configuration frame 300 may be transmitted to the STA with or without frequency multiplexing.

The 802.11ac Group ID and partial AID action frame may be expanded as shown in FIG. 3. For each sub-channel 302A, 302B, or 302C, a member status 304A, 304B, or 304C (e.g., a bitmap field) may indicate to the STA whether the STA is in the particular MU-MIMO group for that particular sub-channel 302A-C. For example, in a member status field with N bits, the i-th bit may indicate an STA's membership status in the i-th MU-MIMO group on this sub-channel (e.g., a “1” indicates the STA is in the i-th MU-MIMO group on this sub-channel and a “0” indicates that the STA is not a member of the i-th MU-MIMO group).

The user position array 306A, 306B, or 306C may indicate an STA's spatial stream position in the specific MU-MIMO group (e.g., as indicated by the member status 304A-C) for the particular sub-channel 302A-C. The two fields, the member status 304A-C and the user position array 306A-C, may be repeated for each sub-channel 302A-C.

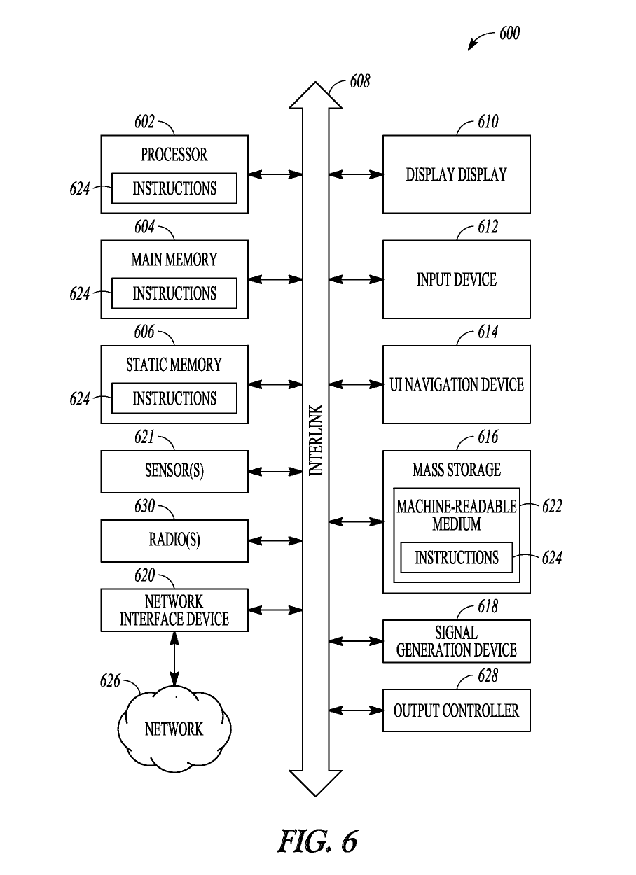

FIG. 4 shows a block diagram of an example of a preamble 400 for DL in MU-MIMO, according to one or more embodiments. Instead of sending the preamble 200B across the entire channel, like is currently done in a DL MU-MIMO transmission, the group ID and spatial stream index in a given sub-channel may be sent on each respective sub-channel. The group ID and spatial stream index (MU NST which may be similar to 802.11ac MU-NST bits in preamble) may be different for different sub-channels. This is illustrated in the sub-channel preambles 402A, 402B, 402C, or 402D in FIG. 4.

A given STA may be configured to receive the sub-channel-preamble 402A-D (or a special SIG field) that it is a member of. The STA will know from the MU Group ID and Partial AID action frame, such as shown in FIG. 3, which group of the sub-channel it is a part of. If the STA's member status for any of the MU-MIMO groups for the particular sub-channel is indicated a “1”, then the station may try to decode the special SIG field.

The sub-channel preamble 402A-D (or the special SIG field) may carry the MU Group ID and MU-NST which indicates station's MU-MIMO spatial stream index to decode on that sub-channel. The sub-channel preamble 402A-D may indicate a decoding scheme to be used on the data streamed in the spatial index that is to be read by the STA.

The legacy preamble 406 may be transmitted across all sub-channels simultaneously (i.e. without using frequency domain multiplexing). The legacy preamble 406 is a preamble in a format that devices currently expect, such as shown in FIG. 2B.

FIG. 5 shows an example of a technique 500 for DL MU-MIMO frequency multiplexing, according to one or more embodiments. At 502, a first MAC management frame may be transmitted (e.g., by a wireless device) to a first STA, such as by a first sub-channel. At 504, a second MAC frame management frame may be transmitted (e.g., by the wireless device) to a second STA, such as by a second sub-channel. The second sub-channel may be different than the first sub-channel (e.g., the second sub-channel may include a different frequency band than the first sub-channel or the second sub-channel may include different data than the first MAC frame). In one or more embodiments, the first and second MAC frames may be transmitted concurrently (e.g., simultaneously). The first or second MAC management frames can be DL MAC frames. The first or second MAC management frames can be transmitted in an OFDMA transmission, by respective MU MIMO spatial streams and over respective sub-channels.

The first and second MAC management frames may include a member status and an STA position index, wherein the member status indicates whether a respective STA is a member of a group of a respective sub-channel and the STA position index indicates a lookup number the respective STA uses to determine a number of spatial streams the respective STA is to monitor for a preamble. The technique 500 can include transmitting over all sub-channels of the plurality of sub-channels (e.g., across the entire channel) a legacy preamble after transmitting the first MAC management frame. The technique 500 can include transmitting a first MU preamble, over the first sub-channel, to the first STA after transmitting the legacy preamble. The technique 500 can include concurrently transmitting with the first MU preamble, a second MU preamble, over the second sub-channel, to the second STA.

The first MU preamble can indicate a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame. The first MU preamble can indicate a MU group identification consistent with the member status of the first MAC management frame.

The technique 500 can include transmitting, by the first sub-channel, first data over the first plurality of MU spatial streams after transmitting the first MU preamble, and concurrently transmitting, by the second sub-channel, second data over the second plurality of MU spatial stream. The first and second data and the first and second MU preambles can be transmitted in accord with an OFDMA technique during a HEW control period comprising a TXOP obtained by the wireless device.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. The machine 600 may be a part of an STA or wireless device as discussed herein. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). The machine 600 may include one or more radios 630 (e.g., transmission, reception, or transceiver devices). The radios 630 may include one or more antennas to receive signal transmissions. The radios 630 may be coupled to or include the processor 602. The processor 602 may cause the radios 630 to perform one or more transmit or receive operations. Coupling the radios 630 to such a processor may be considered configuring the radio 630 to perform such operations.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### ADDITIONAL NOTES

The present subject matter may be described by way of several examples.

Example 1 may include or use subject matter (such as an apparatus, a method, a means for performing acts, or a device readable memory including instructions that, when performed by the device, may configure the device to perform acts), such as may include or use circuitry (e.g., a transceiver configured) to transmit a first DownLink (DL) Medium Access Control (MAC) management frame in an Orthogonal Frequency Division Multiple Access (OFDMA) transmission, by a first Multiple User (MU) Multiple Input Multiple Output (MIMO) spatial stream of a first plurality of MU MIMO spatial streams, to a first Station (STA), over a first sub-channel of a plurality of sub-channels, or concurrently transmit a second DL MAC management frame with the first MAC management frame in the OFDMA transmission, by another MU MIMO spatial stream of a second plurality of MU MIMO spatial streams, to a second STA, over a second sub-channel of the plurality of sub-channels.

Example 2 may include or use, or may optionally be combined with the subject matter of Example 1, to include or use, wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor for a preamble.

Example 3 may include or use, or may optionally be combined with the subject matter of at least one of Examples 1-2, to include or use, wherein the circuitry is further to transmit, simultaneously over all sub-channels of the plurality of sub-channels, a legacy preamble after transmitting the first MAC management frame, transmit a first MU preamble, over the first sub-channel, to the first STA after transmitting the legacy preamble, or concurrently transmit with the first MU preamble, a second MU preamble, over the second sub-channel, to the second STA.

Example 4 may include or use, or may optionally be combined with the subject matter of Example 3, to include or use, wherein the first MU preamble indicates a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame.

Example 5 may include or use, or may optionally be combined with the subject matter of at least one of Examples 3-4, to include or use, wherein the first MU preamble indicates a MU group identification consistent with the member status of the first MAC management frame.

Example 6 may include or use, or may optionally be combined with the subject matter of at least one of Examples 1-5, to include or use, wherein the circuitry is further to transmit, by the first sub-channel, first data over the first plurality of MU spatial streams after transmitting the first MU preamble, and concurrently transmit, by the second sub-channel, second data over the second plurality of MU spatial streams, or wherein the circuitry is further to transmit the first and second data and the first and second MU preambles in accord with an OFDMA technique during a High Efficiency WiFi control period comprising a Transmit Operation (TXOP) obtained by the wireless device.

Example 7 may include or use, or may optionally be combined with the subject matter of at least one of Examples 1-6, to include or use, wherein the circuitry is further to transmit a single MAC management frame simultaneously over all of the sub-channels of the plurality of sub-channels when OFDMA transmissions are not being used.

Example 8 may include or use, or may optionally be combined with the subject matter of at least one of Examples 8 or 14, to include or use (1) wherein the first sub-channel includes a first frequency band and the second sub-channel includes a second frequency band different than the first frequency band, (2) wherein the first and second MAC management frames include a member status and an STA position index, (3) wherein the member status indicates whether a respective STA is a member of a group of a respective sub-channel and the STA position index indicates a lookup number the respective STA uses to determine a number of spatial streams the respective STA is to monitor, (4) wherein the circuitry is further to transmit, by the first sub-channel and after unicast transmitting a legacy preamble, a first MU preamble indicating a first plurality of MU spatial streams that the first STA is to monitor, the first MU preamble indexed in accord with the STA position index transmitted to the first STA, (5) wherein the circuitry is further to concurrently transmit with the first MU preamble, by the second sub-channel, a second MU preamble indicating a second plurality of MU spatial streams that the second STA is to monitor, the second MU preamble indexed in accord with the STA position index transmitted to the second STA, (6) wherein the first and second MU preambles indicate a first and second MU group identifications indicating a sub-channel of the plurality of sub-channels the first and second STAs are to monitor, respectively, (7) wherein the circuitry is further to transmit, by the first sub-channel, first data over the first plurality of multi-user spatial streams, or (8) wherein the circuitry is further to concurrently transmit with the first plurality of multi-user spatial streams, by the second sub-channel, second data over the second plurality of multi-user spatial streams.

Example 9 may include or use subject matter (such as an apparatus, a method, a means for performing acts, or a device readable memory including instructions that, when performed by the device, may configure the device to perform acts), such as may include or use transmitting a first DownLink (DL) Medium Access Control (MAC) management frame in an Orthogonal Frequency Division Multiple Access (OFDMA) transmission, by a first Multiple User (MU) Multiple Input Multiple Output (MIMO) spatial stream of a first plurality of MU MIMO spatial streams, to a first Station (STA), over a first sub-channel of a plurality of sub-channels, and concurrently transmitting a second DL MAC management frame with the first MAC management frame in the OFDMA transmission by another MU MIMO spatial stream of a second plurality of MU MIMO spatial streams, to a second STA, over a second sub-channel of the plurality of sub-channels.

Example 10 may include or use, or may optionally be combined with the subject matter of Example 9, to include or use, wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor for a preamble.

Example 11 may include or use, or may optionally be combined with the subject matter of at least one of Examples 9-10, to include or use transmitting, simultaneously over all sub-channels of the plurality of sub-channels, a legacy preamble after transmitting the first MAC management frame, or transmitting a first MU preamble, over the first sub-channel, to the first STA after transmitting the legacy preamble, and concurrently transmitting with the first MU preamble, a second MU preamble, over the second sub-channel, to the second STA.

Example 12 may include or use, or may optionally be combined with the subject matter of Example 11, to include or use, wherein the first MU preamble indicates a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame.

Example 13 may include or use, or may optionally be combined with the subject matter of at least one of Examples 11-12, to include or use, wherein the first MU preamble indicates a MU group identification consistent with the member status of the first MAC management frame.

Example 14 may include or use, or may optionally be combined with the subject matter of at least one of Examples 9-13, to include or use transmitting, by the first sub-channel, first data over the first plurality of MU spatial streams after transmitting the first MU preamble, and concurrently transmitting, by the second sub-channel, second data over the second plurality of MU spatial streams, or wherein the first and second data and the first and second MU preambles are transmitted in accord with an OFDMA technique during a High Efficiency WiFi (HEW) control period comprising a Transmit Operation (TXOP) obtained by the wireless device.

Example 15 may include or use, or may optionally be combined with the subject matter of at least one of Examples 9-14, to include or use transmitting a single MAC management frame simultaneously over all of the sub-channels of the plurality of sub-channels when OFDMA transmissions are not being used.

Example 16 may include or use, or may optionally be combined with the subject matter of at least one of Examples 9 or 15, to include or use (1) wherein the first sub-channel includes a first frequency band and the second sub-channel includes a second frequency band different than the first frequency band, (2) wherein the first and second MAC management frames include a member status and an STA position index, (3) wherein the member status indicates whether a respective STA is a member of a group of a respective sub-channel and the STA position index indicates a lookup number the respective STA uses to determine a number of spatial streams the respective STA is to monitor, (4) transmitting, by the first sub-channel and after unicast transmitting a legacy preamble, a first MU preamble indicating a first plurality of MU spatial streams that the first STA is to monitor, the first MU preamble indexed in accord with the STA position index transmitted to the first STA, (5) concurrently transmitting with the first MU preamble, by the second sub-channel, a second MU preamble indicating a second plurality of MU spatial streams that the second STA is to monitor, the second MU preamble indexed in accord with the STA position index transmitted to the second STA, (6) wherein the first and second MU preambles indicate a first and second MU group identifications indicating a sub-channel of the plurality of sub-channels the first and second STAs are to monitor, respectively, (7) transmitting, by the first sub-channel, first data over the first plurality of multi-user spatial streams, or (8) concurrently transmitting with the first plurality of multi-user spatial streams, by the second sub-channel, second data over the second plurality of multi-user spatial streams.

Example 17 may include or use subject matter (such as an apparatus, a method, a means for performing acts, or a device readable memory including instructions that, when performed by the device, may configure the device to perform acts), such as may include or use circuitry (e.g., a transceiver configured) to transmit to a plurality of STAs a MAC configuration frame without frequency multiplexing, transmit to a first STA on a first sub-channel a first data frame, or transmit (e.g., concurrently with the first data frame) to a second STA on a second sub-channel different than the first sub-channel, a second data frame different from the first data frame.

Example 18 may include or use, or may optionally be combined with the subject matter of Example 17, to include or use, wherein the first sub-channel is a first frequency band and the second sub-channel is a second frequency band different than the first frequency band.

Example 19 may include or use, or may optionally be combined with the subject matter of Example 18, to include or use, wherein the MAC configuration frame includes a member status and an STA position index, wherein the member status indicates whether a respective STA is a member of a group of a respective sub-channel and the station position index indicates a lookup number the respective STA uses to determine a number of spatial streams the respective STA is to monitor.

Example 20 may include or use, or may optionally be combined with the subject matter of Example 18, to include or use, wherein: (1) the first sub-channel includes a first frequency band and the second sub-channel includes a second frequency band different than the first frequency band, (2) the MAC configuration frame includes a member status and an STA position index, wherein the member status indicates whether a respective STA is a member of a group of a respective sub-channel and the STA position index indicates a lookup number the respective STA may use to determine a number of spatial streams the respective STA is to monitor, (3) the circuitry is further to transmit a legacy preamble (e.g., after transmitting the MAC configuration frame) on the plurality of sub-channels (e.g., without frequency multiplexing), (4) the circuitry is further to transmit, by the first sub-channel and after transmitting the legacy preamble, a first multi-user preamble indicating a first plurality of multi-user spatial streams indexed in accord with the STA position index transmitted to the first STA, (5) the circuitry is further to concurrently transmit with the first multi-user preamble, by the second sub-channel, a second multi-user preamble indicating a second plurality of multi-user spatial streams indexed in accord with the STA position index transmitted to the second STA, or (6) the first and second multi-user preambles indicate a first and second multi-user group identification consistent with the member status of the MAC configuration frame.

Example 21 may include or use subject matter (such as an apparatus, a method, a means for performing acts, or a device readable memory including instructions that, when performed by the device, may configure the device to perform acts), such as may include or use transmitting to a plurality of STAs a MAC configuration frame without frequency multiplexing, transmitting to a first STA on a first sub-channel a first data frame, or transmitting to a second STA (e.g., concurrently with the first data frame) on a second sub-channel different than the first sub-channel, a second data frame different from the first data frame.

Example 22 may include or use, or may optionally be combined with the subject matter of Example 21, to include or use, wherein the first sub-channel includes a first frequency band and the second sub-channel includes a second frequency band different than the first frequency band.

Example 23 may include or use, or may optionally be combined with the subject matter of Example 21, to include or use, wherein the MAC configuration frame includes a member status and an STA position index, wherein the member status indicates whether a respective STA is a member of a group of a respective sub-channel and the station position index indicates a lookup number the respective STA uses to determine a number of spatial streams the respective STA is to monitor.

Example 24 may include or use, or may optionally be combined with the subject matter of Example 23, to include or use, wherein: (1) the first sub-channel includes a first frequency band and the second sub-channel includes a second frequency band different than the first frequency band, (2) the MAC configuration frame includes a member status and an STA position index, wherein the member status indicates whether a respective STA is a member of a group of a respective sub-channel and the STA position index indicates a lookup number the respective STA uses to determine a number of spatial streams the respective STA is to monitor, (3) transmitting a legacy preamble (e.g., after transmitting the MAC configuration frame) on the plurality of sub-channels (e.g., without frequency multiplexing), (4) transmitting, by the first sub-channel and after transmitting the legacy preamble, a first multi-user preamble indicating a first plurality of multi-user spatial streams indexed in accord with the STA position index transmitted to the first STA, (5) concurrently transmitting with the first multi-user preamble, by the second sub-channel, a second multi-user preamble indicating a second plurality of multi-user spatial streams indexed in accord with the STA position index transmitted to the second STA, or (6) wherein the first and second multi-user preambles indicate a first and second multi-user group identification consistent with the member status of the MAC configuration frame.

Example 25 may include or use, or may optionally be combined with the subject matter of at least one of Examples 1-8 or 17-20, to include or use a processor, a memory coupled to the processor, at least one radio coupled to the processor, or at least one antenna coupled to the radio.

The above detailed description includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1-20. (canceled)

21. A wireless device including a transceiver configured to:
transmit a first DownLink (DL) Medium Access Control (MAC) management frame in an Orthogonal Frequency Division Multiple Access (OFDMA) transmission, by a first Multiple User (MU) Multiple Input Multiple Output (MIMO) spatial stream of a first plurality of MU MIMO spatial streams, to a first Station (STA), over a first sub-channel of a plurality of sub-channels; and
concurrently transmit a second DL MAC management frame with the first MAC management frame in the OFDMA transmission, by another MU MIMO spatial stream of a second plurality of MU MIMO spatial streams, to a second STA, over a second sub-channel of the plurality of sub-channels.

22. The wireless device of claim 21, wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor for a preamble.

23. The wireless device of claim 22, wherein the transceiver is further configured to:
transmit, simultaneously over all sub-channels of the plurality of sub-channels, a legacy preamble after transmitting the first MAC management frame;
transmit a first MU preamble, over the first sub-channel, to the first STA after transmitting the legacy preamble; and
concurrently transmit with the first MU preamble, a second MU preamble, over the second sub-channel, to the second STA.

24. The wireless device of claim 23, wherein the first MU preamble indicates a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame.

25. The wireless device of claim 24, wherein the first MU preamble indicates a MU group identification consistent with the member status of the first MAC management frame.

26. The wireless device of claim 24, wherein the transceiver is further configured to:
transmit, by the first sub-channel, first data over the first plurality of MU spatial streams after transmitting the first MU preamble; and
concurrently transmit, by the second sub-channel, second data over the second plurality of MU spatial streams,
wherein the transceiver is configured to transmit the first and second data and the first and second MU preambles in accord with an OFDMA technique during a High Efficiency WiFi control period comprising a Transmit Operation (TXOP) obtained by the wireless device.

27. The wireless device of claim 21, wherein the transceiver is configured to:
transmit a single MAC management frame simultaneously over all of the sub-channels of the plurality of sub-channels when OFDMA transmissions are not being used.

28. A method performed by a wireless device comprising:
transmitting a first DownLink (DL) Medium Access Control (MAC) management frame in an Orthogonal Frequency Division Multiple Access (OFDMA) transmission, by a first Multiple User (MU) Multiple Input Multiple Output (MIMO) spatial stream of a first plurality of MU MIMO spatial streams, to a first Station (STA), over a first sub-channel of a plurality of sub-channels; and
concurrently transmitting a second DL MAC management frame with the first MAC management frame in the OFDMA transmission by another MU MIMO spatial stream of a second plurality of MU MIMO spatial streams, to a second STA, over a second sub-channel of the plurality of sub-channels.

29. The method of claim 28, wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor for a preamble.

30. The method of claim 29, further comprising:
transmitting, simultaneously over all sub-channels of the plurality of sub-channels, a legacy preamble after transmitting the first MAC management frame; and
transmitting a first MU preamble, over the first sub-channel, to the first STA after transmitting the legacy preamble; and
concurrently transmitting with the first MU preamble, a second MU preamble, over the second sub-channel, to the second STA.

31. The method of claim 30, wherein the first MU preamble indicates a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame.

32. The method of claim 31, wherein the first MU preamble indicates a MU group identification consistent with the member status of the first MAC management frame.

33. The method of claim 31, further comprising:
transmitting, by the first sub-channel, first data over the first plurality of MU spatial streams after transmitting the first MU preamble; and
concurrently transmitting, by the second sub-channel, second data over the second plurality of MU spatial streams;
wherein the first and second data and the first and second MU preambles are transmitted in accord with an OFDMA technique during a High Efficiency WiFi (HEW) control period comprising a Transmit Operation (TXOP) obtained by the wireless device.

34. The method of claim 28, further comprising:
wherein the first sub-channel includes a first frequency band and the second sub-channel includes a second frequency band different than the first frequency band;
wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor;
transmitting, by the first sub-channel and after unicast transmitting a legacy preamble, a first MU preamble indicating a first plurality of MU spatial streams that the first STA is to monitor, the first MU preamble indexed in accord with the STA position index transmitted to the first STA;
concurrently transmitting with the first MU preamble, by the second sub-channel, a second MU preamble indicating a second plurality of MU spatial streams that the second STA is to monitor, the second MU preamble indexed in accord with the STA position index transmitted to the second STA;
wherein the first and second MU preambles indicate a first and second MU group identifications indicating a sub-channel of the plurality of sub-channels the first and second STAs are to monitor, respectively;
transmitting, by the first sub-channel, first data over the first plurality of multi-user spatial streams; and
concurrently transmitting with the first plurality of multi-user spatial streams, by the second sub-channel, second data over the second plurality of multi-user spatial streams.

35. A non-transitory computer readable medium comprising instructions stored thereon, which when executed by a machine, configure the machine to:
transmit a first DownLink (DL) Medium Access Control (MAC) management frame in an Orthogonal Frequency Division Multiple Access (OFDMA) transmission, by a first Multiple User (MU) Multiple Input Multiple Output (MIMO) spatial stream of a first plurality of MU MIMO spatial streams, to a first Station (STA), over a first sub-channel of a plurality of sub-channels; and
concurrently transmit a second DL MAC management frame in the OFDMA transmission with the first MAC management frame by another MU MIMO spatial stream of a second plurality of MU MIMO spatial streams, to a second STA, over a second sub-channel of the plurality of sub-channels.

36. The medium of claim 35, wherein the first and second MAC management frames include a member status and an STA position index, wherein the member status indicates whether a respective STA is a member of a group of a respective sub-channel and the STA position index indicates a lookup number the respective STA uses to determine a number of spatial streams the respective STA is to monitor for a preamble.

37. The medium of claim 36, further comprising instructions, which, when executed by the machine, configure the machine to:
transmit, simultaneously over all sub-channels of the plurality of sub-channels, a legacy preamble after transmitting the first MAC management frame; and
transmit a first MU preamble, over the first sub-channel, to the first STA after transmitting the legacy preamble; and
concurrently transmitting with the first MU preamble, a second MU preamble, over the second sub-channel, to the second STA.

38. The medium of claim 37, wherein the first MU preamble indicates a MU spatial stream on the first sub-channel the first STA is to decode in accord with the STA position index from the first MAC management frame and wherein the second MU preamble indicates a MU spatial stream index on the second sub-channel the second STA is to decode in accord with the STA position index from the second MAC management frame.

39. The medium of claim 38, wherein the first MU preamble indicates a MU group identification consistent with the member status of the first MAC management frame.

40. The medium of claim 38, further comprising instructions, which, when executed by the medium, configure the machine to:
transmit, by the first sub-channel, first data over the first plurality of MU spatial streams after transmitting the first MU preamble; and
concurrently transmit, by the second sub-channel, second data over the second plurality of MU spatial streams;
wherein the first and second data and the first and second MU preambles are transmitted in accord with an OFDMA technique during a High Efficiency WiFi (HEW) control period comprising a Transmit Operation (TXOP) obtained by the machine.
